(19) United States
(12) Patent Application Publication
(10) Pub. No.: US 2004/0046708 A1
(43) Pub. Date: Mar. 11, 2004

(54) System and method for presenting still images or motion sequences to passengers onboard a train moving in a tunnel

(76) Inventor: Alexander Yurusov, Taipei (TW)

Correspondence Address: ALEXANDER YURUSOV, 5F, NO. 17, HANG SHENG EAST ROAD, PANCHIAO, TAIPEI, 220, TW

(21) Appl. No.: 10/065,002

(22) Filed: Sep. 9, 2002

(51) Int. Cl. G09G 5/00

(52) U.S. Cl. 345/1.3

(57) ABSTRACT

System and method for presenting still images or motion sequences to passengers onboard a train moving in a tunnel. System comprises a plurality of vertically mounted light emitting bars placed in a row on a tunnel sidewall at specific intervals in the direction of a train movement. Each bar emits light, which is modulated according to the desired image, time of the beginning of each train window and a train velocity. Movement of the observer-passenger onboard a train relatively to the light emitting bars is used to form a visible still image or motion sequence. Displayed content can be different for another observer-passenger located against another window of the same train.

### BACKGROUND OF INVENTION

1. Technical Field

The present invention relates to a system and a method for presenting still images or motion sequence to the passengers onboard a moving train. It is well known that passengers during a train trip can look through windows. However, during nighttime or during passing a tunnel there is no good window view that entertains passengers.

This situation is common for city public transportation systems—metro and subway, which most of the times are located under the ground. Having a trip on a train under the ground a passenger enjoys only a picture of a dark tunnel wall.

2. Related Art

A prior art system for presenting images to passengers onboard a moving train is disclosed in the U.S. Patent Application 20020003510, Jan. 13, 1999, Shigetomi. Shigetomi uses a plurality of LCD panels, each being capable to flash by its backlight for instantaneous display of a still-frame image. Also Shigetomi uses velocity detection for controlling timing of display of still-frame images.

The prior art system described above, however, has a high cost because of a plurality of expensive LCD panels. Also size of an image is limited by the size of LCD panel and according to the available today LCD technology it is much smaller than a size of a train window. Also an image has a visible horizontal distortion because of a train movement and afterimage effect. This distortion depends on a train speed and a time the backlight is on. Higher train speed causes larger image distortion. Shortening the time when backlight is on leads to a darker image. Also this prior art system displays the same still image or motion sequence to all the passengers onboard of a train.

The MotionPosters Company Limited from UK discloses another prior art system. MotionPosters utilizes a sequence of printed-paper sheets fixed at a tunnel sidewall and uses a flashlight triggered when a train window aligned with a paper sheet. This prior art system, however, does not allow a frequent change of motion image, has the same visible horizontal distortion as described above and displays the same motion sequence to all the windows and to all the passengers onboard a train.

### SUMMARY OF INVENTION

It is an object of the present invention to provide a device for displaying still images or motion sequence to the passengers onboard of a moving train.

Most of passenger trains, especially trains used in city public transportation systems, such as metro or subway, are unified in type and have the same length and the same positions, sizes and geometry of windows. This information together with information about the train position and speed, obtained from a train velocity and position detector, is sufficient for a light emitting bar installed on a tunnel sidewall to detect the time each window's border reaches a light emitting bar and to modulate a light according to the train speed in order to create an image visible to a passenger looking through the said window onboard the said train.

From the point of view of a passenger moving onboard a train, a light emitting bar passes a window with a high speed in a fraction of a second. Due to the inertness of a human eye, limited by a window frame view and a high speed of a light emitting bar the said passenger-observer sees a complete flat image instead of a single moving light emitting bar.

Vertical visible size of an image depends on a height of a light emitting bar. Horizontal visible size of an image depends on a display time. In principle, visible size of an image is limited to a passenger-observer only by a window frame.

Several light emitting bars, which sequentially pass the said observer“s window and display images of a motion sequence, form a short movie visible to the said observer. When all light emitting bars display the same image, an observer sees a stable still image instead of a motion sequence.

The total time of demonstration depends on a number of installed light emitting bars, the distance between them and the speed of a train.

Each light emitting bar stores several images in order to display different images to different train windows at different time thus raising passengers“ interest. In principle, the number of images in a single bar is limited only by a size of an image memory unit, located inside a bar.

As far as all images are stored electronically it is easy to create and update the displaying content by the means of wired or wireless data transfer thus increasing display system flexibility and delivering urgent information or commercial content.

### BRIEF DESCRIPTION OF DRAWINGS

FIG. 1 is a perspective view of a vertical longitudinal section of a tunnel for illustrating a principle of display system installation.

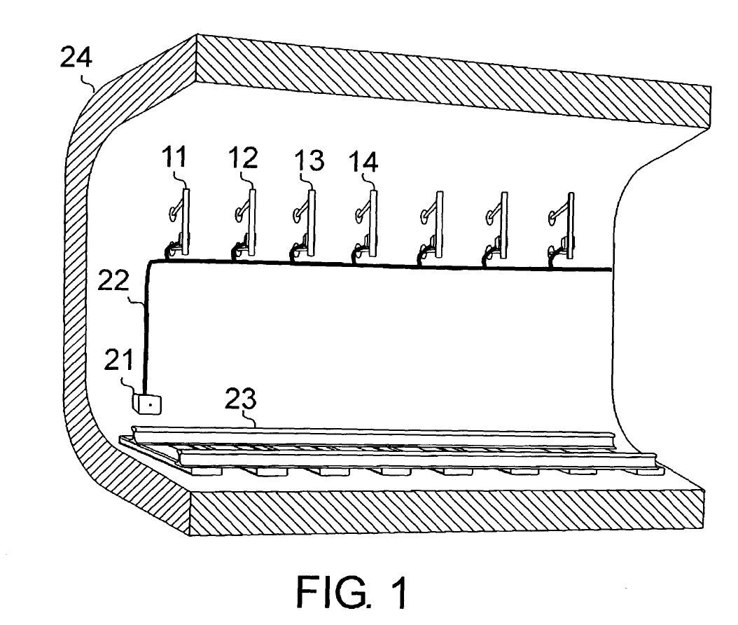

FIG. 2 is a view of a vertical cross section of a tunnel for illustrating a train passing display system in a tunnel.

FIG. 3 is a view for illustrating images that passengers observe when a train passing display system.

FIG. 4A to FIG. 4C are diagrams of a light emitting bar composing a symbol “S” during train passing display system in a tunnel.

FIG. 5A to FIG. 5D are schematic top views for illustrating different stages of a display system operation.

FIG. 6 is a block diagram for illustrating a structure and principles of operation of a train velocity and position detector.

FIG. 7 is a block diagram of a light emitting bar.

### DETAILED DESCRIPTION

6FIG. 1 is a perspective partial view of a vertical longitudinal section of a train tunnel 24, where a preferred embodiment is installed. Several light emitting bars 11, 12, 13, 14 and more are located on a sidewall of a tunnel 24. A train velocity and position detector 21 is mounted on a tunnel sidewall on a level of train wheels. All light emitting bars are connected to a train velocity and position detector 21 by a signal cable 22.

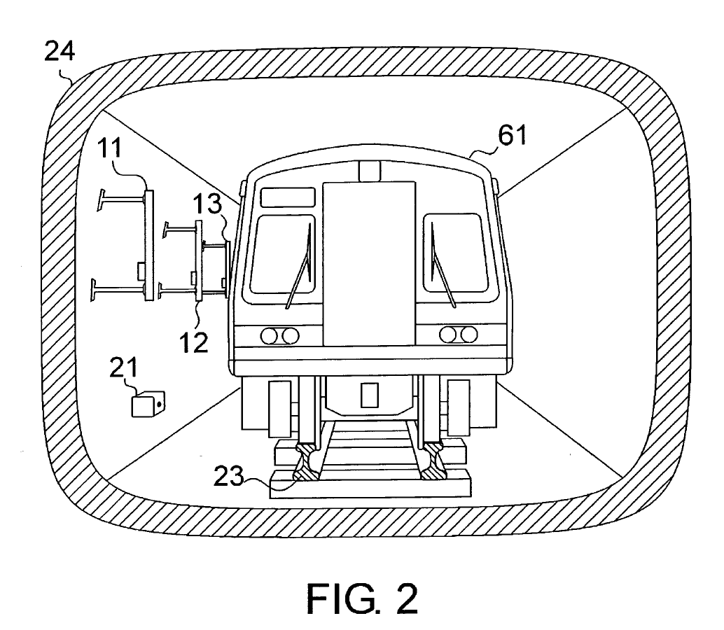

Light emitting bars from 11 to 14 and all other bars have the same construction and are mounted in a vertical position in a row along a tunnel with a given interval between each other. All the bars are mounted on the same height relatively to a rail track 23 and this height corresponds to a window level of a train 61 as shown in FIG. 2.

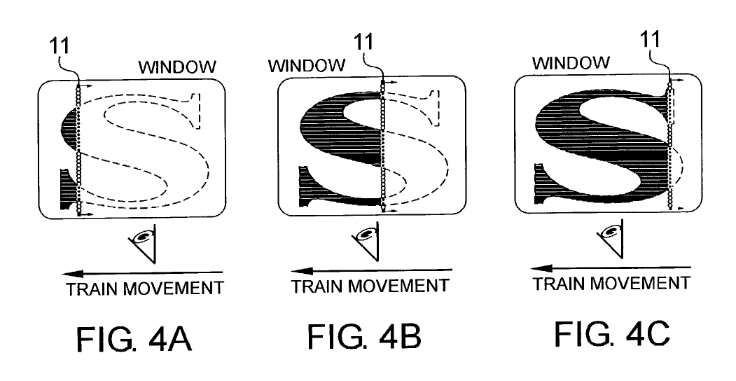

FIG. 4A to FIG. 4C illustrate several stages of a light emitting bar composing a symbol “S” during train passing display system in a tunnel. Observer is onboard of a train and is moving together with a train relatively to the light emitting bar 11 fixed on a tunnel sidewall. From an observer“s point of view, a window is stable, but a light emitting bar 11 passes a window with a train speed in the direction opposite to the train movement direction. Light, emitted by a bar 11 is modulated according to the symbol “S” and according to the current train speed obtained from the train velocity and position detector 21. Due to the afterimage effect, observer does not see a moving bar, but sees a symbol “S” instead. Position of a symbol “S” is centered horizontally to a window size based on the “train reached the detector” signal obtained from a train velocity and position detector 21 and based on a known geometry of a train.

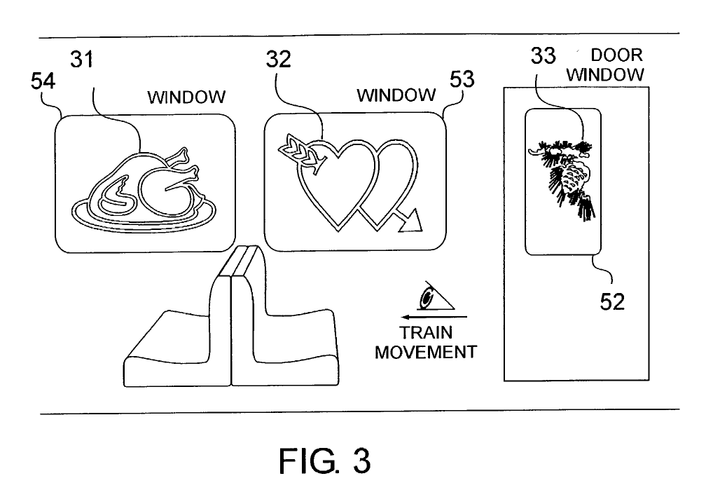

FIG. 3 is a view for illustrating images that passengers observe when a train passes the display system. Each light emitting bar displays different image into different window of a train. This is possible because positions and sizes of all windows of a train are predetermined for the trains of the same type and the beginning of a train obtained from a train velocity and position detector 21. An example is shown in a FIG. 3, where image 31 is displayed in a window 54; image 32 is displayed in a window 53; image 33 is displayed in a door window 52 and having vertical and horizontal size different to the images 31 and 32.

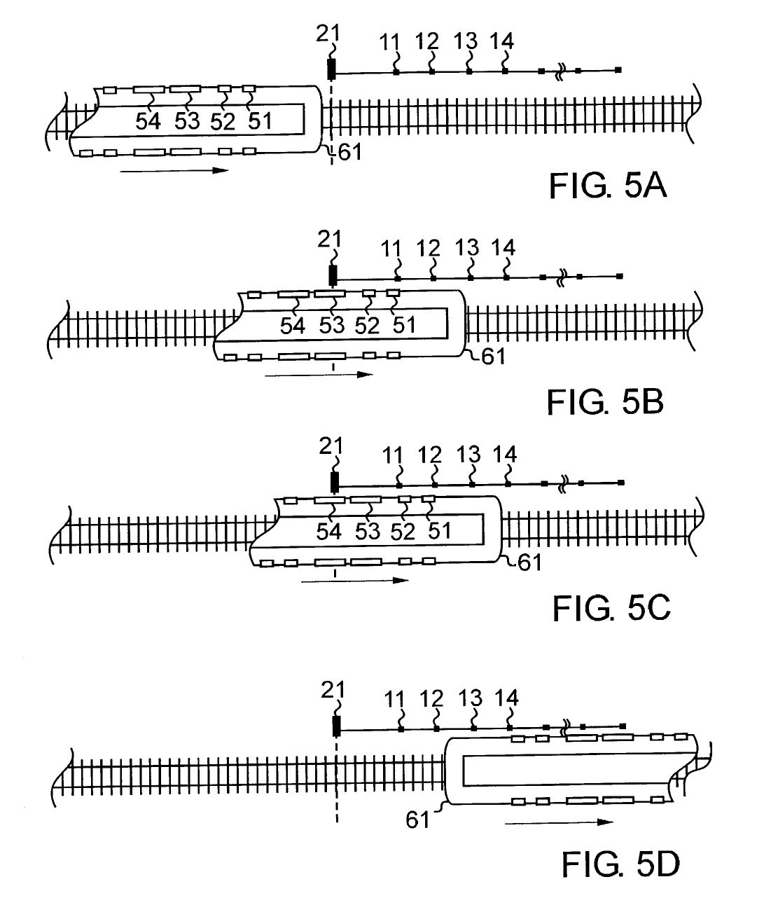

FIG. 5A to FIG. 5D are schematic top views for illustrating different stages of a display system operation.

FIG. 5A illustrates a situation when a train is approaching a display system. Position of a train is not detected; all light emitting bars are dark.

FIG. 5B illustrates a situation when a train speed and position are already detected; light bar 11 begins to display the first frame for the window 51. Light emitting bars 12, 13, 14 and others are still dark.

FIG. 5C illustrates a situation when the light bar 12 starts to display the second frame for the window 51. At this moment the light bar 11 has finished displaying the first frame for the window 51. Light emitting bars 13, 14 and others are still dark.

FIG. 5D illustrates the situation when the light bar 14 has finished displaying the forth frame into the last window of a train. Light emitting bars 11, 12, 13 are already dark. Other light emitting bars continue displaying images according to a train position. The train has already passed the train position and velocity detector 21. Detector 21 continues to output speed information to light emitting bars based on the previously measured train velocity and acceleration until the train leaves the display system installation.

In case the total system length is bigger than that of a train and at this location a train velocity usually changes substantially, several train velocity and position detectors can be installed with the intervals shorter than a train's length.

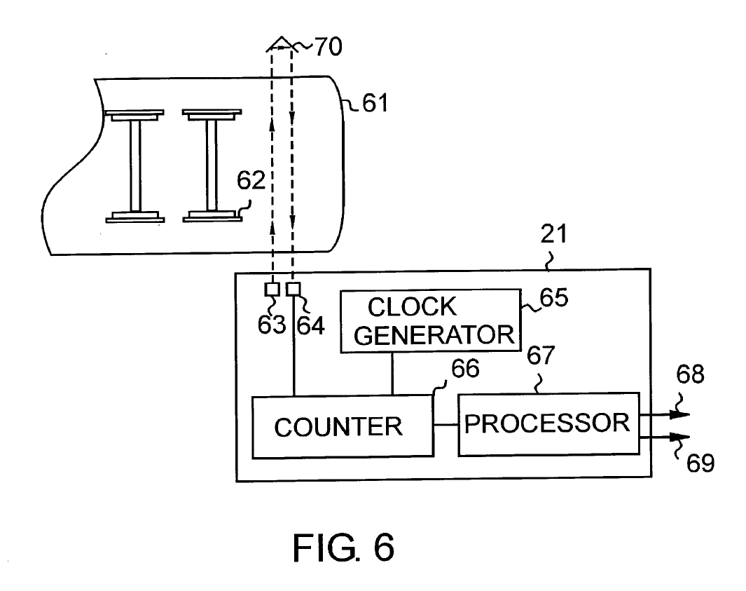

Structure and principles of operation of a train velocity and position detector are illustrated in FIG. 6. A train velocity and position detector 21 has a light beam transmitter 63. Light beam from transmitter 63 crosses a tunnel on the level of train wheels. The mirror 70, mounted on the opposite sidewall of a tunnel 24, reflects the said light beam back to the receiver 64. When the train 61 passes the system installation, train wheels 62 interrupt the light beam for a certain period of time. The purpose of the clock generator 65 and the counter 66 is to measure the time during which the light beam is interrupted by train wheels with the given accuracy. Train speed value can be obtained by dividing the known linear size of a train wheel on the beam level by the measured time. A processor 67 performs this calculation. A train velocity and position detector 21 outputs two principle signals: signal 68 is a pulse that indicates the moment a train reaches the detector; signal 69 is a pixel clock that corresponds with a train speed. For example, when train speed is 60 km/h and pixel pitch is 3.6 mm the frequency of a pixel clock will be equal to 4,630 Hz.

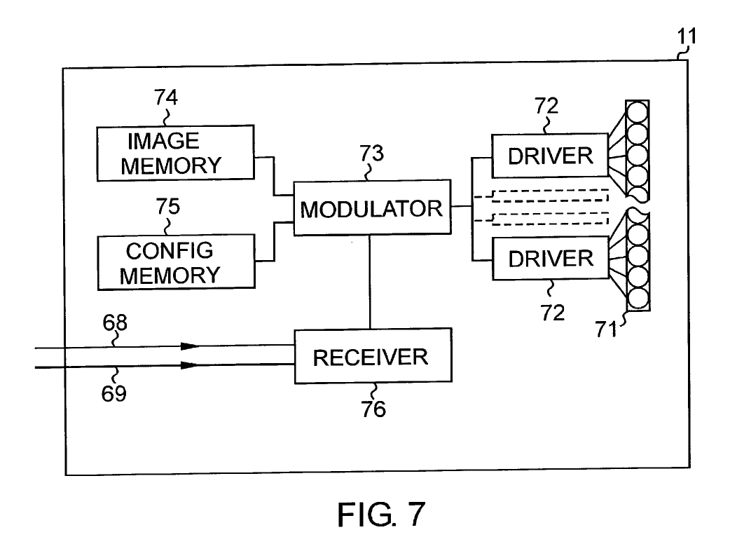

FIG. 7 is a block diagram of a light emitting bar 11. Receiver 76 receives signals 68 and 69 described above. Configuration memory 75 stores offset and horizontal size of each train window in pixel units and offset of this light emitting bar relatively to a train begin detect pulse in pixel units. Image number and column number inside this image that should be displayed at the present moment, can be calculated based on the above information and the total number of pixels counted since the train begin pulse was generated.

Image memory 74 stores image bitmaps. Modulator 73 reads the column of the current image to display and distributes light intensity information through the drivers 72. Each driver 72 drives several light emitting cells forming a light-emitting column 71.

Reasonable height of a light emitting bar 11 can be chosen based on a simple calculation of the area visible from a train window, on a desired image size, desired image vertical resolution and the size of the available light emitting cell. For example, the required image vertical resolution is 240 pixels, which corresponds to the NTSC video standard; vertical size of available light emitting cell is 3.2 mm for a surface mounted LED with a vertical mounting pitch of 3.6 mm. Thus a visible vertical image size can be calculated as 864 mm.

An interval between light emitting bars can be chosen in a wide range and mostly depends on desired image horizontal width and resolution, an average train speed at this part of a tunnel, actual brightness of a light-emitting cell. For example, required horizontal resolution is 320 pixels, which corresponds to the NTSC video standard, pixel pitch was chosen in an example above and is equal to 3.6 mm. Thus a visible horizontal image size can be calculated as 1152 mm. An interval between light emitting bars can be chosen based on the above information to be equal to a visible horizontal image size and equal to 1152 mm. In this case the next light emitting bar will begin to display the next frame of a motion sequence right after the previous bar finished displaying the previous frame.

Actual quantity of light emitting bars depends on a desired show time and on an interval between bars. For example, with an 152 mm interval between light emitting bars, one hundred of installed bars will provide a 6.9 seconds of show time for train moving with a speed of 60 km/h and will occupy more than one hundred meters of a tunnel sidewall length.

Frame rate for a given above example and a train speed of 60 km/h is 14.5 frames per second. For a train moving with a speed of 80 km/h show time will be 5.2 seconds with a frame rate of 19.3 frames per second.

In order to display still images or motion sequences to both sides of a train, another row of light emitting bars can be installed on the opposite sidewall of a tunnel. This said another row can be independent with its own train velocity and position detector or can use train position and velocity signals from the detector, installed on an opposite side of a tunnel.

1. A method of displaying still images or motion sequences into each window of a passenger train, moving in a tunnel, by installing a plurality of vertically mounted light emitting bars on a tunnel sidewall that are placed in a row at a window level of a train at specific intervals in the direction of a train movement, where said bars emit light, modulated according to the desired image, time the border of each train window reaches a light emitting bar and a train velocity; and using movement of an observer onboard a train relatively to the said light emitting bars to make the said still image or motion sequence visible to the said observer.

2. A system, mounted on a sidewall of a train tunnel and comprises:
a train velocity and position detector;
a plurality of vertically mounted light emitting bars placed in a row at a window level of a train at specific intervals in the direction of a train movement; where each light emitting bar comprises a control circuit and a plurality of light emitting cells aligned at a specific dot interval; where each light emitting cell is a plurality of LEDs capable to emit a full-color light;
signal cables from a train velocity and position detector to light emitting bars are used to time-synchronize the modulated light emitted by bars with a train speed and position.
